(19) United States
(12) Patent Application Publication
(10) Pub. No.: US 2015/0161609 A1
(43) Pub. Date: Jun. 11, 2015

(54) SYSTEM AND METHOD FOR RISK AND FRAUD MITIGATION WHILE PROCESSING PAYMENT CARD TRANSACTIONS

(71) Applicant: Cube, Co., Mountain View, CA (US)

(72) Inventor: Joel Christner, Mountain View, CA (US)

(73) Assignee: Cube, Co., Mountain View, CA (US)

(21) Appl. No.: 14/099,729

(22) Filed: Dec. 6, 2013

(51) Int. Cl. G06Q 20/40

(52) U.S. Cl. CPC G06Q 20/4016

(57) ABSTRACT

A system and method is provided for detecting fraud during merchant on-boarding. A transaction processing system receives a payment request from a merchant and retrieves merchant metadata associated with a merchant profile based on the payment request. The system determines an initial risk score for the transaction based, at least in part, on the merchant metadata. The risk score may then be dynamically adjusted based on the received payment request and the merchant metadata. The system may further determine, based on the risk score, whether to notify a system administrator of a high risk transaction, request a review of the transaction by the system administrator, and/or decline the transaction.

### TECHNICAL FIELD

Examples described herein relate to commercial transactions, and more specifically, to detecting and/or mitigating risk of fraud during merchant on-boarding.

### BACKGROUND

In recent years, point-of-sale devices and systems have implemented technology that takes advantage of the increasingly functional performance provided by consumer electronic devices such as smart phones and tablets. While in years past, point-of-sale devices were limited to cash registers and credit card terminals (e.g., magnetic readers), present day provides merchants with miniaturized accessory devices that can be connected to consumer electronic devices (e.g., tablets) that use software applications to process transactions and accept funds.

### SUMMARY

This Summary is provided to introduce in a simplified form a selection of concepts that are further described below in the Detailed Description. This summary is not intended to identify key features or essential features of the claimed subject matter, nor is it intended to limit the scope of the claimed subject matter.

A system and method of operation are disclosed that may aid in fraud detection when processing payment card transactions. A transaction processing system receives a payment request from a merchant and retrieves merchant metadata associated with a merchant profile based on the payment request. An initial risk score for the transaction is determined based, at least in part, on the merchant metadata. The system then dynamically adjusts the risk score based on the received payment request and the merchant metadata. For some embodiments, the system may determine, based on the risk score, whether to: send a notification message to a system administrator indicating a high risk transaction; request a review of the transaction by the system administrator; and/or decline the transaction.

The payment request may include a payment amount for the commercial transaction and/or payment card information. For some embodiments, the system may increase the risk score if the payment card information has been used in one or more previous transactions within a threshold duration prior to the commercial transaction. More specifically, the risk score may be increased if the payment amount is reduced for each subsequent one of the one or more previous transactions. For other embodiments, the system may increase the risk score if the payment amount exceeds a threshold transaction size. Furthermore, the merchant metadata may include a previous amount charged by the merchant during a first period and a transaction limit for the first period. For some embodiments, the system may increase the risk score if the sum of the payment amount and the previous amount charged during the first period is equal to one or more predetermined transaction limits.

The merchant metadata may include an age value corresponding to a length of time for which the merchant profile has been active, and may also indicate a number of payments transacted by the merchant since the merchant profile has been active. For some embodiments, the system may increase the risk score if the age value is below an age threshold. For other embodiments, the system may increase the risk score if the number of payments transacted by the merchant is below a payment threshold. For example, the age value may be reduced if the number of payments transacted by the merchant is below the payment threshold.

The merchant metadata may include chargeback information and/or indicate a frequency of declined payments. For some embodiments, the system may increase the risk score if the chargeback information indicates one or more open chargebacks or disputes from cardholders. For other embodiments, the system may increase the risk score if the frequency of declined payments exceeds a card-sweeping threshold. Furthermore, the merchant metadata may include an email address for the merchant. For some embodiments, the system may increase the risk score if the email address is associated with a public domain or a free service.

By associating a risk score to each payment request, and dynamically adjusting the risk score based on the payment request and historical transaction data, a merchant may build up trustworthiness with the transaction processing system. Thus, payment requests received from trustworthy merchants may be processed more quickly and/or efficiently than payment requests received from newer or less trustworthy merchants. Furthermore, adjusting the age value for the merchant based on the number of payments transacted prevents merchants from automatically building trustworthiness over time (i.e., through inaction).

### BRIEF DESCRIPTION OF THE DRAWINGS

The present embodiments are illustrated by way of example and are not intended to be limited by the figures of the accompanying drawings where:

FIG. 1 illustrates a system for conducting commercial transactions in accordance with some embodiments;

FIG. 2 is an illustrative flow chart depicting a payment processing fraud detection operation in accordance with some embodiments;

FIG. 3 is an illustrative flow chart depicting a more detailed embodiment of a payment processing fraud detection operation;

FIG. 4 is an illustrative flow chart depicting a risk evaluation operation in accordance with some embodiments; and

FIG. 5 is a block diagram that illustrates a computer system upon which embodiments described herein may be implemented.

### DETAILED DESCRIPTION

In the following description, numerous specific details are set forth such as examples of specific components, circuits, and/or processes to provide a thorough understanding of the present disclosure. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. The interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

Examples described herein provide a system and method for detecting and/or mitigating merchant fraud while processing payment card transactions. As used herein, a “merchant” refers to a company or business (e.g., Wal-Mart, Pep Boys, McDonald's, Philz Coffee, etc.) that provides goods and/or services. Furthermore, a particular merchant may be associated with a single outlet (e.g., wherein the merchant is a store owner) or multiple outlets (e.g., wherein the merchant is a franchise). An “operator” herein refers to an actual user (e.g., director, manager, employee, or other type of personnel) that is associated with a particular merchant.

According to some embodiments, a system for conducting commercial transactions receives a payment request from an approved merchant. The system uses information provided with the payment request to retrieve merchant metadata associated with a merchant profile stored in a merchant database, and determines an initial risk score for the transaction based on the merchant metadata. The system then dynamically adjusts the risk score based on the received payment request and the merchant metadata. The risk score may be evaluated to determine one or more additional actions to be taken by the transaction processing system, including, for example: sending a notification message to a system administrator indicating a high risk transaction; requesting a review of the transaction by the system administrator; and/or declining the transaction.

Among other benefits, examples described herein recognize that merchants or individuals (e.g., “fraudsters”) may attempt to defraud the transaction processing system by submitting payment requests using false or stolen payment information (e.g., credit card information). For example, a merchant may be limited to the number and/or amount of payments it can process through the system during a given period (e.g., this amount may be capped at $500/day for key-in transactions). Thus, a fraudster may attempt to maximize illicit gains by charging an amount equal to the payment cap each period (e.g., using a stolen credit card). Under conventional implementations, fraudulent transactions are detected by a cardholder (e.g., after seeing an unauthorized charge on his/her credit card statement) or by the card-issuing bank (e.g., based on known purchasing patterns of the cardholder).

However, examples herein recognize that fraud at the merchant level may be difficult, if not impossible, to prevent under conventional implementations. For example, a merchant fraudster may have already absconded with the money by the time a cardholder notices the unauthorized charge on his/her account. Furthermore, issuing banks typically do not monitor merchant behavior for purposes of detecting fraud. Therefore, examples herein provide a mechanism for determining and/or evaluating the “riskiness” of each transaction initiated by a merchant. The transaction processing system may then take appropriate action to prevent and/or mitigate fraud based on the riskiness of the transaction.

Examples described herein also recognize that the riskiness of any transaction may be determined, in part, by historical data pertaining to the merchant. For example, transactions initiated by merchants with younger and/or less active merchant profiles may be riskier than those initiated by older or more active merchants, since a merchant with a record of non-fraudulent transactions may have established a certain level of trustworthiness with the system. Furthermore, examples herein recognize that the riskiness of a given transaction may also be determined based on information included with a payment request. For example, a payment request with a large transaction size (e.g., payment amount) may be riskier than a payment request with a smaller transaction size, since the transaction processing system stands to lose a greater sum of money in the event of fraud. Therefore, the riskiness of a given transaction may be assessed based on a payment request received from the merchant and/or merchant metadata associated with a merchant profile for that merchant.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Architecture

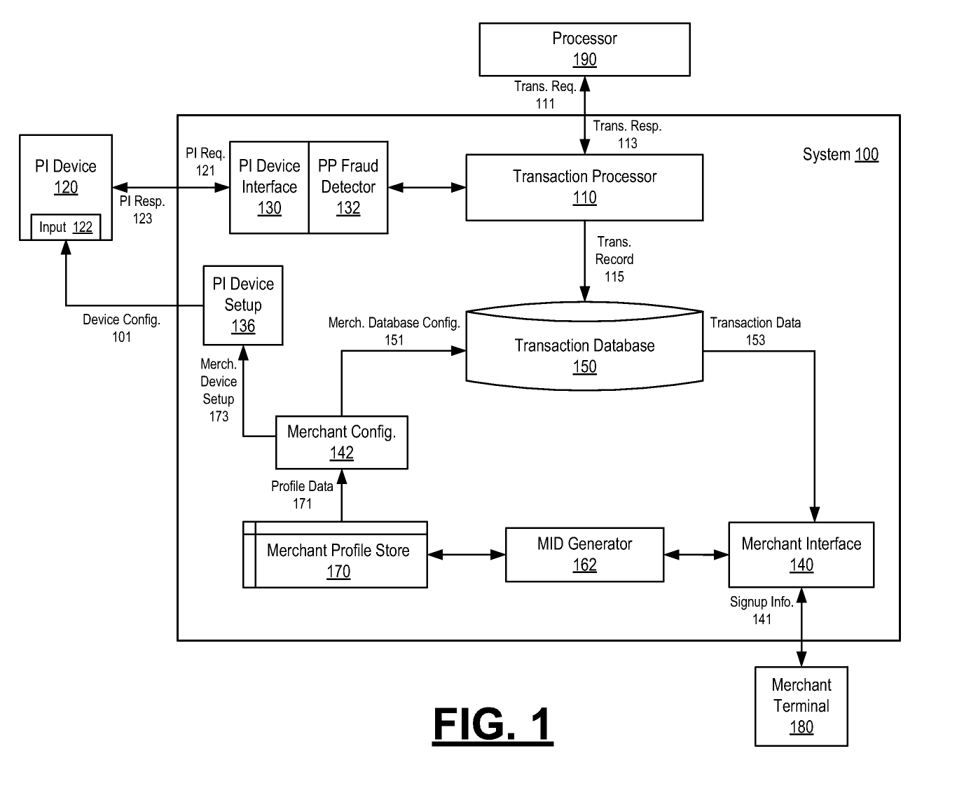

FIG. 1 illustrates an exemplary system for conducting commercial transactions in accordance with present embodiments. With reference to FIG. 1, a payment input (PI) device 120 can be operated by a merchant to access a transaction processing system 100. The PI device 120 may correspond to, for example, a point of sale (POS) device and/or a credit card terminal (CCT). The transaction processing system 100 can be provided as a network service, such as a cloud-based service, or software deployed in the merchant's data center. In one implementation, the transaction processing system 100 is a multi-tenant cloud-based service that hosts merchant transactional activity and services for multiple merchants.

According to some embodiments, the system 100 can include a transaction processing sub-system 110, a transaction database 150, and a merchant interface 140. A given merchant (or operator for the merchant) can access system 100 via merchant interface 140. For example, the merchant may access the system 100 over the Internet, using a web browser, and the interface 140 can be provided as a web page. During merchant “on-boarding” (i.e., the process by which a merchant registers with the system 100 and/or creates a new merchant profile), the merchant provides signup information 141 to the system 100 using a merchant terminal 180. The merchant terminal 180 may correspond to any computing device (e.g., computer, cell phone, tablet, PDA, etc.) capable of interacting with the system 100 via the merchant interface 140.

The signup information 141 may include input data entered by the merchant, as well as metadata associated with the merchant terminal 180. More specifically, the input data may include personally-identifying information and/or business-identifying information. Examples of personally-identifying information include: a name, address, date of birth, social security number, phone number, email address, bank account, and/or password associated with an individual or operator. Examples of business-identifying information include: a name, address, phone number, web address, and/or tax ID associated with a company or business. Furthermore, the metadata may include information specifying a device type, device ID, internet protocol (IP) address, and/or geolocation coordinates of a location of the merchant terminal 180 when used to submit the input data.

A new merchant profile may be created, for example, by storing profile information for the merchant in the merchant profile store 170. The merchant profile may include some or all of the signup information 141. For example, each merchant profile may include a merchant identifier (MID), location identifiers, device identifiers, and/or role designations for the particular merchant. As an addition or alternative, the profile store 170 can also be used to maintain merchant-specified device configurations and information. For some embodiments, a merchant account (MID) generator 162 may assign a MID to the merchant prior to storing the new merchant profile in the merchant profile store 170. MIDs are typically issued by an acquiring bank to enable the merchant to use the acquiring bank's services in processing credit card transactions. Each MID is further associated with one or more terminal identifiers (TIDs) which are used to link the merchant's payment terminals with the corresponding merchant account.

In some instances, a merchant may have an existing merchant account (e.g., MID) with an acquiring bank. Thus, for some embodiments, the merchant interface 140 may allow the merchant to input its own MID/TID information. The MID generator 162 may mark the MID to indicate that it is a merchant-preferred MID. If the merchant does not have an existing MID, or has no preference regarding which acquiring bank and/or processor the system 100 uses to process transactions, the merchant account generator 162 may create a new merchant account with a default (e.g., pre-selected) acquiring bank and processor. Accordingly, the merchant account generator 162 may assign a new MID and one or more TIDs for the merchant.

The merchant may then associate one or more PI devices 120 for use with the system 100. For simplicity, only one PI device 120 is shown in exemplary embodiment of FIG. 1. The PI device 120 may be a software configurable device that can provide POS and/or CCT functionality through, for example, an application or programmatic interface. In such implementations the PI device 120 may correspond to a multi-purpose computing device, including mobile computing devices such as computers, smartphones, and/or tablets. For some embodiments, the PI device 120 may be configured with merchant-specific software configurations to enable various kinds of usages, including franchise-based usage where the merchant is a multi-point merchant. The merchant may associate the PI device 120 with a particular store location and/or one or more employees of that store (e.g., based on role assignments).

Once a merchant profile has been successfully created, a merchant configurator 142 retrieves profile data 143 stored in the merchant profile store 170 and generates device setup instructions 173 as well as database configuration instructions 151 for the merchant. The device setup instructions 173 may identify all of the PI devices associated with the merchant, and may include configuration instructions for each device. For example, the device setup instructions 173 may include a MID, one or more TIDs, and software and/or hardware configurations for enabling PI devices to create and process transactions through the system 100.

The PI device setup logic 136 receives the device setup instructions 173 from the merchant configurator 142 and generates device configuration instructions 101 for each PI device 120 associated with the merchant. The PI device setup logic 136 may determine, from the device setup instructions 173, how the PI device 120 is to be configured (e.g., which employee(s) may initiate transactions, what inventory items can be sold, what price is to be associated with each item, etc.). The device 120 may then request or retrieve the configuration instructions 101 from the PI device setup logic 136. The device configuration instructions 101 may include the TID assigned to the PI device 120 as well as device-specific software configuration instructions. For example, the device configuration instructions 101 may include a list of items that may be sold through PI device 120 and/or a list of employees that are allowed access (e.g., to log in) to PI device 120.

The database configuration instructions 151 include parameters (e.g., fields and/or tables) to be created for the merchant in the transaction database 150. For example, the database configuration instructions 151 may identify the merchant, store locations, inventory items, and/or employees associated with the merchant. The transaction database 150 may store information pertaining to a payment history (e.g., for successfully processed payments and/or chargebacks) for the merchant. For example, the database configuration instructions 151 may be used to create: a merchant field for storing data (e.g., merchant sales reports) pertaining to the merchant as a whole; one or more location fields that are linked or associated with the merchant field for storing data (e.g., location-based sales reports) specific to a particular store and/or location; and one or more inventory and employee fields that are linked or associated with each store location field for storing inventory and employee records (e.g., transaction records) from a particular PI device associated with that store location. For some embodiments, individual operators may only be allowed selective access to the information stored in the transaction database 150 (e.g., based on their particular role assignments).

Once the merchant configurator 142 has finished setting up the PI device 120 and transaction database 150, a transaction can be initiated through the given PI device 120. An employee or operator of the PI device 120 may create a transaction for a particular store item on the PI device 120. For example, the employee may specify the item(s) and quantity to be sold via a user interface (UI) provided on the PI device 120. The employee may then input the customer's payment information (e.g., credit card account number, expiration date, cardholder's name, etc.) via an input mechanism 122.

For some embodiments, the input mechanism 122 may be a card reader which receives inputs in the form of a card “swipe.” For example, most credit cards are issued in the form of a magnetic stripe card wherein credit card information (e.g., card or account number, cardholder's name, expiration date, etc.) is stored on a magnetic stripe (“magstripe”) on the reverse side of the card. When the credit card is swiped, the input mechanism 122 may read the credit card information stored on the magstripe and forward this data to the PI device 120 for further processing. For example, the input mechanism 122 may be a peripheral device that is connected or coupled to the PI device 120. Alternatively, the input mechanism 122 may be integrated with the PI device 120.

As an additional or alternative embodiment, the input mechanism 122 may be configured to receive character-based inputs. For example, the input mechanism 122 may include a keyboard or keypad which enables the user to manually “key in” a customer's credit card number and/or other information. As described in greater detail below, for some embodiments, transactions may be processed differently depending on the type of input mechanism used. For example, if the input mechanism 122 is a card reader, a customer must physically produce a credit card to be input (e.g., swiped) into the card reader. Thus, a card swipe input may confirm that the credit card was actually in the customer's possession when the transaction was made, whereas a keyed-in input could not. Card swipe inputs are therefore considered more secure, in general, than keyed-in inputs.

Upon receiving payment information, the PI device 120 signals a payment (PI) request 121 to system 100 through a network such as the Internet. The PI request 121 may include the customer's payment information (e.g., credit card information and amount to be charged to the card), as well as device metadata associated with the PI device 120 (e.g., device type, device ID, IP address, and/or geolocation information). For some embodiments, the payment information may include information identifying the items being purchased (including quantity of each item), itemized cost of the transaction (including any discounts that may have been applied), the location of the PI device 120, employee information (identifying the employee making the sale), and merchant information (e.g., merchant name, MID, and/or TID).

The PI request 121 is sent to a PI device interface 130 which may selectively forward the request 121 to the transaction processor 110. For some embodiments, a payment processing (PP) fraud detector 132 may determine the riskiness of the transaction based on the received PI request 121. For example, the PP fraud detector 132 may associate a risk score with the PI request 121 based on information provided with the PI request (e.g., payment amount and/or payment card information) and merchant metadata associated with a merchant profile for the particular merchant (e.g., age and payment history of merchant profile, email domain, historical transaction data, and/or chargeback information).

For some embodiments, the risk score may be dynamically adjusted to reflect the merchant's level of trustworthiness based on current and past transactions. For example, a merchant having a long history of successful transactions (e.g., involving no chargebacks and/or known incidences of fraud) may pose less of a risk than a new merchant with relatively few transactions. Thus, the risk score associated with a merchant's subsequent transactions may reduce over time as the merchant successfully transacts more and more payments via the system 100.

Further, for some embodiments, the PP fraud detector 132 may evaluate the risk score associated with the PI request 121 and may take additional steps to prevent and/or mitigate potential fraud. For example, the PP fraud detector 132 may compare the risk score to a number of predetermined risk thresholds each configured to trigger one or more remedial actions. Such remedial actions may include: sending a notification message to a system administrator indicating a high risk transaction; requesting a review of the transaction by the system administrator; and/or declining the transaction.

Assuming the payment request 121 is approved (e.g., as low-risk and/or non-fraudulent) by the PP fraud detector 132, the PI device interface 130 may selectively assign a payment processor to process payment information from the PI request 121 depending on a merchant preference. For example, as discussed above, the merchant may have a pre-existing MID with a processor that it wishes to use for all credit card transactions. Accordingly, the PI device interface 130 may parse the merchant metadata from the PI request 121 to first determine whether the merchant has selected to use its own existing MID/TID, or whether a new MID/TID was assigned by the MID generator 162. For example, if PI request 121 includes a merchant-preferred MID, the PI device interface 130 may simply forward the request 121 on to the transaction processor 110 without modification. Accordingly, the PI device interface 130 may dynamically associate the PI device 120 with a new payment processor (e.g., by altering the MID/TID information of the PI request 121) only if a new MID/TID was assigned by the MID generator 162 and/or the merchant did not indicate a preference for a particular payment processor.

The PI device interface 130 then forwards the PI request 121 to the transaction processor 110, which transmits a transaction request 111 to a corresponding payment processor 190 based on the MID/TID information included with the PI request 121 and/or routing information provided by the PI device interface 130. For some embodiments, the transaction processor 110 may perform a number of authentication and/or verification operations on the received PI request 121 prior to even generating a transaction request 111. For example, the transaction processor 110 may first verify that: the merchant operator initiating the transaction is permitted to make such a sale; the item(s) being sold are properly associated with the merchant that is selling them; and whether a credit card was physically used to make the purchase. As discussed above, the transaction processor 110 may limit the amount that may be transacted (e.g., in a day, week, month, and/or year) if the payment information was keyed in manually, for example, by blocking any transaction that would exceed the transaction limit associated with the received payment information.

Once a PI a request 121 has been authenticated, the transaction processor 110 stores a record of the transaction (e.g., transaction record 115) in the transaction database 150. The transaction processor 110 then transmits the transaction request 111 to the payment processor 190. The transaction request 111 may include the customer's payment information (e.g., credit card number, expiration date, cardholder's name, etc.) and other transaction information (e.g., items purchased, price paid, merchant information, etc.). For some embodiments, the transaction processor 110 may send the transaction request 111 to any one of multiple payment processors based on the MID/TID information included with the PI request 121.

The payment processor 190 then acquires the funds (i.e., the requested payment) on behalf of the merchant. For example, the payment processor 190 may route the transaction request 111 through the appropriate card network (e.g., Visa, MasterCard, American Express, Discover, etc.) to the issuing bank. The issuing bank authenticates the transaction request 111 and responds by either approving or declining the transaction. For example, the issuing bank may verify that the transaction information is valid, the customer has sufficient credit to make the purchase, and the customer's account with the issuing bank is in good standing. This process is known as “authorization.” If the issuing bank approves the transaction, it may place a hold on the funds to be transferred to the acquiring bank. The issuing bank returns a transaction response 113 (e.g., approved/declined), which is routed back through the processor 190 and sent to the transaction processor 110.

The transaction processor 110 stores the transaction response 113 with the associated transaction record 115, awaiting settlement. For some embodiments, if the issuing bank 172 declines a transaction, the transaction processor 110 may send a PI response 123 to the PI device 120 indicating that the transaction was declined and delete the transaction record 115 associated therewith. Alternatively, the transaction processor 110 may write to the stored transaction record 115 indicating that the corresponding transaction was declined.

The transaction processor 110 may subsequently initiate a “settlement” process (e.g., which typically occurs at the end of each business day) to capture the held funds. For example, the transaction processor 110 may route information identifying the approved transactions back to the issuing bank, via the processor 190. The issuing bank then deposits the appropriate funds in a master merchant account of an acquiring bank associated with a system operator (i.e., the operator of the transaction processing system 100). The amount deposited in the master merchant account may be equal to the gross receipts (i.e., the amount owed by customers) less interchange/network fees owed to the card network and processing fees owed to the processor 190 (and/or acquiring bank). Finally, the acquiring bank deposits the funds acquired by the master merchant account to a particular merchant's deposit account. For some embodiments, the transaction processor 110 may control or manage the transfer of funds from the master merchant account to the merchant deposit account. For example, the transaction processor 110 may instruct the acquiring bank to deduct the system operator's transaction fees from the amount deposited to the merchant deposit account. The system operator's transaction fees may thus be retained in the master merchant account.

To access transaction data 153 stored in the transaction database 150, an operator first logs in through the merchant interface 140. For some embodiments, the merchant interface 140 may determine the operator's role assignment and retrieve role-specific data. For example, the role-specific data may include selected data items from the transaction database 150 that the particular operator is allowed access to, based on the operator's role assignment.

METHODOLOGY

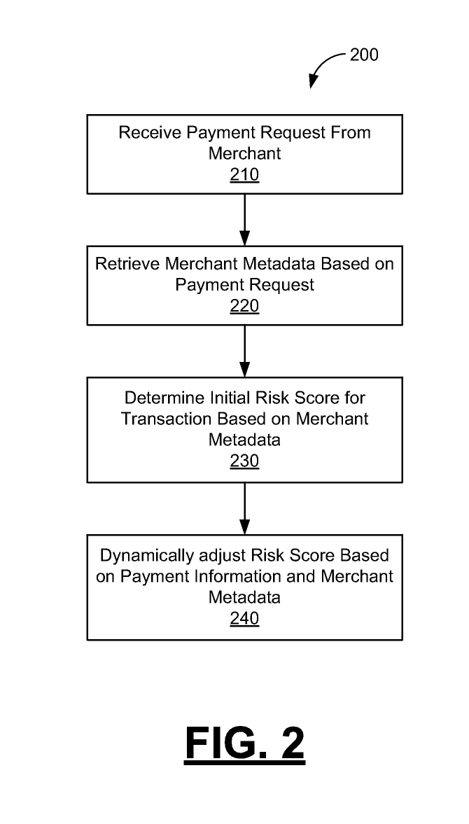

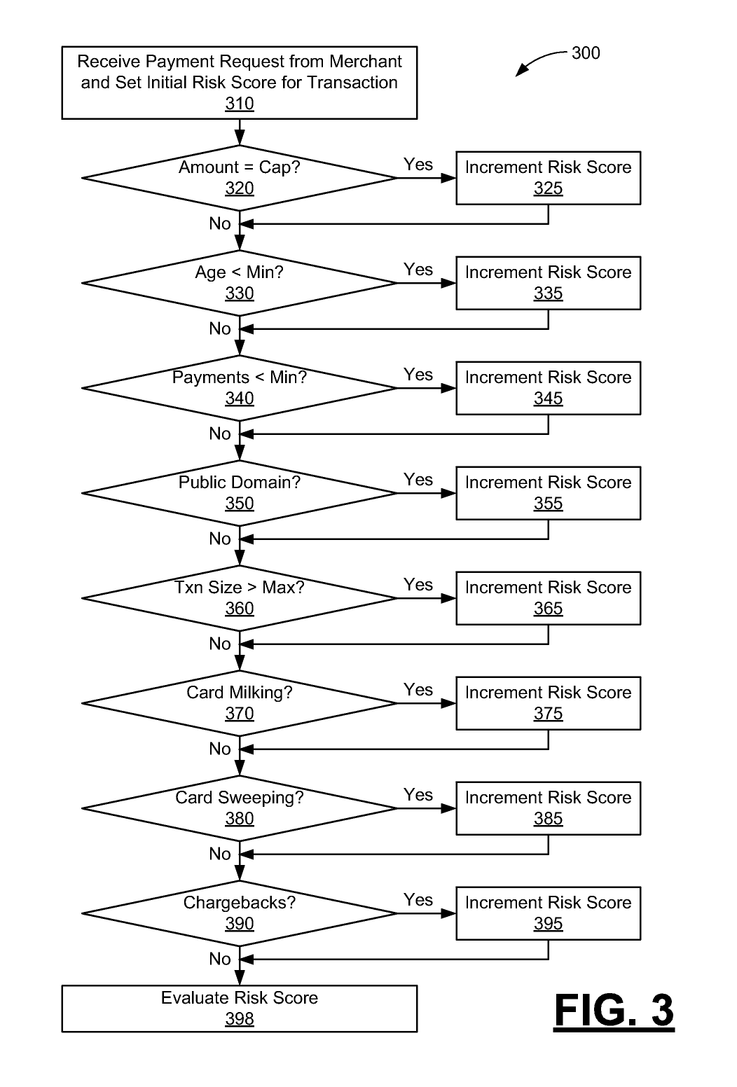

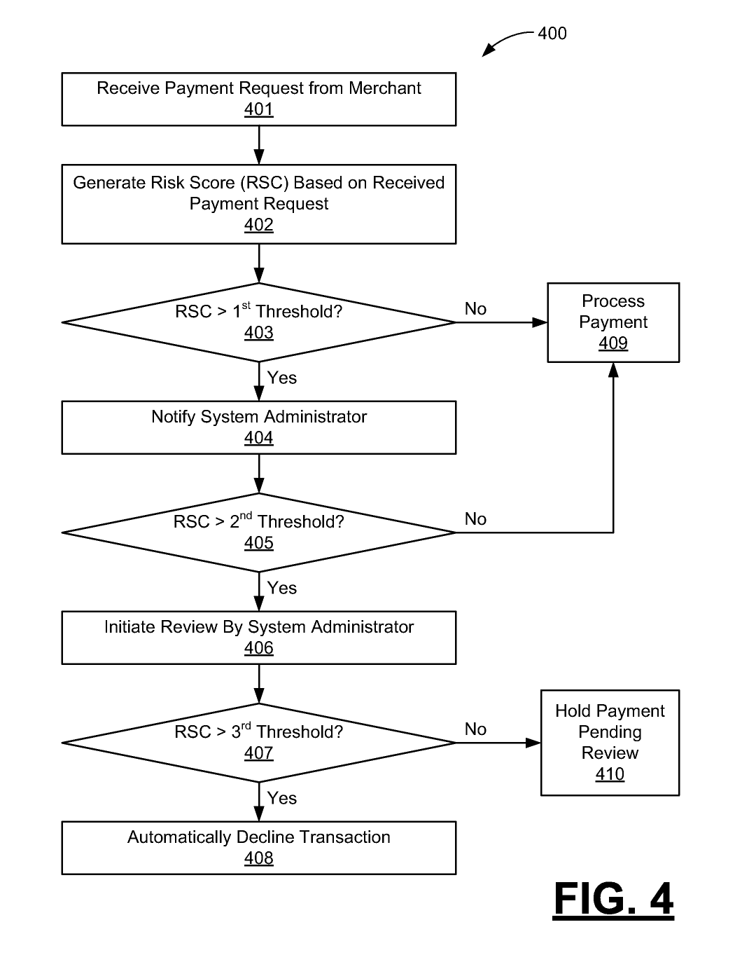

FIGS. 2 and 3 are illustrative flow charts depicting a payment processing fraud detection operation in accordance with some embodiments. FIG. 4 is an illustrative flow chart depicting a risk evaluation operation in accordance with some embodiments. Methods such as described by examples of FIGS. 2-4 may be implemented using, for example, a system such as described with respect to FIG. 1. Accordingly, reference may be made to elements of FIG. 1 for purpose of illustrating suitable components for performing a step or sub-step being described.

FIG. 2 is an illustrative flow chart 200 depicting a payment processing fraud detection operation in accordance with some embodiments. With respect to FIG. 2, the system 100 initially receives a payment request from a merchant (210). For example, the payment request (e.g., PI request 121) may include payment information for the transaction and device metadata associated with the device (e.g., PI device 120) used to submit the payment request. The payment information may include credit card information and an amount to be charged to the card. For some embodiments, the payment information may also include merchant-identifying information (e.g., merchant name, MID, and/or TID). The device metadata may include a device type, device ID, IP address, and/or geolocation information.

The system 100 first retrieves merchant metadata based on the payment request (220). For example, the PP fraud detector 132 may identify a particular merchant profile stored in the merchant profile store 170 based on the merchant-identifying information provided with the PI request 121. The PP fraud detector 132 may then retrieve a set of merchant metadata stored with the particular merchant profile. The merchant metadata may include, for example: age and payment history for the merchant profile, email domain, and/or historical transaction data.

The system 100 then determines an initial risk score for the transaction based, at least in part, on the merchant metadata (230). The initial risk score may correspond to a baseline value that is pre-associated with any transaction initiated by a particular merchant. For example, the initial risk score may be set to zero when a new merchant first sets up a merchant profile with the system 100. For some embodiments, the initial risk score may increase and/or decrease over time based on merchant activity. For example, the initial risk score may be set to a higher value for a merchant that submits a number of payment requests which the system 100 flags as high-risk. On the other hand, the initial risk score may be set lower for an established merchant with very few high-risk transactions on its record.

Further, for some embodiments, a system administrator may set the initial risk score for a new merchant to a predetermined value (i.e., other than zero) during merchant on-boarding. For example, if the merchant is a large reputable company (e.g., Wal-Mart), the system administrator may set the initial risk score to a very low value (e.g., −500) in order to prevent the system 100 from scrutinizing each and every transaction initiated by the merchant (since it is highly unlikely Wal-Mart would steal credit card information or attempt to defraud the system 100). This also ensures that system and administrative resources are reserved for evaluating high-risk transactions initiated by less trustworthy merchants.

Finally, the system 100 dynamically adjusts the risk score based on the received payment request and the merchant metadata (240). Specifically, the risk score may be dynamically adjusted to reflect the merchant's level of trustworthiness based on current and past transactions, as well as other factors associated with the merchant. For example, a payment request submitted by a merchant having a long history of successful transactions (e.g., involving no chargebacks and/or known incidences of fraud) may be considered less risky than a new merchant with relatively few transactions. For some embodiments, the system 100 may selectively increment the initial risk score (which represents a baseline value for the particular transaction) based on a number of risk-based sub-analyses, for example, as described in greater detail below.

FIG. 3 is an illustrative flow chart 300 depicting a more detailed embodiment of a payment processing fraud detection operation. With reference, for example, to FIG. 1, the system 100 first receives a payment request from a merchant and sets an initial risk score for the transaction (310). As described above, the payment request may include payment information for the transaction, as well as device metadata associated with the device used to submit the payment information. The payment information may include credit card information, an amount to be charged to the card (i.e., payment amount), and merchant-identifying information (e.g., merchant name, MID, and/or TID). The device metadata may include a device type, device ID, IP address, and/or geolocation information.

The PP fraud detector 132 may retrieve merchant metadata associated with a particular merchant profile stored in the merchant profile store 170 based on the merchant-identifying information provided with the payment request. The merchant metadata may include, for example: age and payment history for the merchant profile, a merchant email domain, and/or historical transaction data (e.g., indicating a total amount transacted, a number of declined payments, and/or any chargebacks attributed to the merchant profile). The PP fraud detector 132 may then determine the initial risk score based, at least in part, on the merchant metadata. As described above, the initial risk score may correspond to a baseline value (e.g., zero) that is pre-associated with any transaction initiated by a particular merchant. For some embodiments, the initial risk score may be increased and/or decreased over time, based on merchant activity. For other embodiments, the initial risk score may be set (e.g., by a system administrator) to a predetermined value during merchant on-boarding.

Once the initial risk score is determined, the system 100 may proceed to determine whether the current transaction would put the total amount transacted by the merchant for a given period at or above a payment cap for that period (320). For example, the PP fraud detector 132 may determine the total amount transacted during the given period based on the merchant metadata. The PP fraud detector 132 may then add the requested payment amount (included in the payment request) to the total amount transacted and compare the sum to the payment cap. For example, as described above, there may be a relatively high risk of fraud if the sum total is exactly equal to the payment cap. Thus, if the total payment amount for the given period would be equal to the payment cap (320), the PP fraud detector 132 may proceed to increment the risk score (325). It should be noted that, for some embodiments, the system 100 may automatically decline the payment request if the total payment amount for the given period would exceed the payment cap.

The system 100 may then compare the age of the merchant profile with a minimum age threshold (330). The age of the merchant profile may be determined, for example, from an age value included with the merchant metadata. The minimum age threshold may correspond with a predetermined age value (e.g., 90 days) above which the PP fraud detector 132 considers merchants to be low-risk. For example, a merchant that has been processing transactions through the system 100 over a long period of time is more likely to be trustworthy (i.e., lower risk) than a relatively new merchant. Thus, if the age value is below the minimum age threshold (330), the PP fraud detector 132 may proceed to increment the risk score (335). For some embodiments, the PP fraud detector 132 may compare the age value to a number of different age thresholds (e.g., 30, 60, 90 days, etc.) and increment the risk score by varying amounts depending on the age threshold(s) surpassed by the age value.

The system 100 may then compare the number of payments transacted by the merchant with a minimum transaction threshold (340). For example, the merchant metadata may include a record of the total number of payments transacted by the merchant since the merchant account was activated. The minimum transaction threshold may correspond with a predetermined number of payments (e.g., 50 payments) above which the PP fraud detector 132 considers merchants to be low-risk. For example, a merchant that has processed more payments through the system 100 is more likely to be trustworthy (i.e., lower risk) than a relatively new merchant. Thus, if the number of payments is below the minimum transaction threshold (340), the PP fraud detector 132 may proceed to increment the risk score (345). For some embodiments, the PP fraud detector 132 may compare the number of payments transacted by the merchant to a number of different transaction thresholds (e.g., 10, 20, 50 payments, etc.) and increment the risk score by varying amounts depending on the transaction threshold(s) surpassed by the number of payments.

For other embodiments, the PP fraud detector 132 may adjust the age value for the merchant profile based on the number of payments transacted. For example, a merchant profile that is old (e.g., 180 days) but has been used very infrequently (e.g., processed only 1 payment) may still be considered high-risk. Thus, the PP fraud detector 132 may adjust or normalize the age value for the merchant profile based on the number of payments transacted by the merchant. For example, a merchant profile that is technically 180 days old may have an adjusted age value of 10 days if it has been used to process only 1 payment during the 180 days. This would cause the risk score for the merchant to be incremented based on both the age of the merchant profile (330) and the number of payments transacted by the merchant (340).

The system 100 may then determine whether the email address for the merchant is associated with a public domain (350). The merchant's email address may be determined, for example, from the merchant metadata. Typically, an email address that is hosted on a public domain (e.g., Yahoo Mail, Gmail, Live, Hotmail, Me, etc.) or other free service may be considered high-risk, since public email accounts can easily be created (and often are) for fraudulent purposes. Thus, if the merchant's email address is associated with a public domain or other free service (350), the PP fraud detector 132 may proceed to increment the risk score (355).

The system 100 may further compare the requested payment amount with a maximum transaction threshold (360). The maximum transaction threshold may correspond with a predetermined payment amount above which the PP fraud detector 132 considers merchants to be high-risk. For some embodiments, the maximum transaction threshold may be a percentage of the merchant's payment cap for a given period. For example, a single transaction for a very large amount (e.g., 90% of the payment cap) may be considered high-risk, since it is less likely for a stolen credit card to be declined (i.e., detected as lost or stolen) if used in only one transaction. Thus, if the payment amount is above the maximum transaction threshold (360), the PP fraud detector 132 may proceed to increment the risk score (365). For some embodiments, the PP fraud detector 132 may compare the payment amount to a number of different transaction thresholds (e.g., 70%, 80%, 90% of the payment cap, etc.) and increment the risk score by varying amounts depending on the transaction thresholds surpassed by the payment amount.

The system 100 may then determine whether the merchant has charged the same payment card multiple times in given period (e.g., risk of “card milking”) (370). The given period may correspond to a predetermined duration (e.g., 1 hour) within which multiple charges to the same payment card may raise suspicions of card milking. For example, a fraudster may “test” a stolen credit card by first charging a relatively small or innocuous amount to it. If the transaction is not declined, the fraudster may then proceed to “milk” the card for more money (e.g., up to the credit card limit). Thus, if the payment card (which may be identified from the payment card information included in the payment request) has already been used in a previous transaction within the given period (370), the PP fraud detector 132 may proceed to increment the risk score (375). For some embodiments, the PP fraud detector 132 may increment the risk score by varying amounts depending on the number of times the payment card was used during the given period.

The system may further determine whether the merchant has had multiple declined transactions within a given period (e.g., risk of “card sweeping”) (380). The number of declined transactions may be determined, for example, from the merchant metadata. In this case, the given period may correspond to a predetermined duration (e.g., 1 hour) within which multiple declined transactions (e.g., using different payment cards) may raise suspicions of card sweeping. For example, a fraudster in possession of a number of stolen credit cards may often “sweep” through (i.e., attempt to charge) multiple cards before finding one that can subsequently be milked (i.e., is not declined). Thus, if the merchant has had multiple declined transactions within the given period (380), the PP fraud detector 132 may proceed to increment the risk score (385). For some embodiments, the PP fraud detector 132 may increment the risk score by varying amounts depending on the number of declined transactions during the given period.

The system 100 may then determine whether there are any open chargebacks associated with the merchant profile (390). Chargeback information may be determined, for example, from the merchant metadata. A chargeback occurs when the system 100 reimburses a cardholder for a disputed (e.g., fraudulent) charge. Thus, if a merchant has one or more open chargebacks associated with its merchant profile (390), the PP fraud detector 132 may proceed to increment the risk score (395). For some embodiments, the PP fraud detector 132 may increment the risk score by varying amounts depending on the number of open chargebacks associated with the merchant profile.

Finally, the system 100 may evaluate the risk score to determine whether further remedial action should be taken. As described in greater detail below, such remedial actions may include: notifying a system administrator of the transaction; requesting review of the transaction by the system administrator; and/or declining the transaction.

FIG. 4 is an illustrative flow chart 400 depicting a risk evaluation operation in accordance with some embodiments. With reference, for example, to FIG. 1, the system 100 first receives a payment request from a merchant (401). As described above, the payment request may include payment information for the transaction and device metadata associated with the device used to submit the payment information. The payment information may include credit card information, an amount to be charged to the card (i.e., payment amount), and merchant-identifying information (e.g., merchant name, MID, and/or TID). The device metadata may include a device type, device ID, IP address, and/or geolocation information.

The system 100 may then generate a risk score based on the received payment request (402). For example, the PP fraud detector 132 may determine the risk score based on information provided with the payment request and merchant metadata associated with a merchant profile for the particular merchant. Specifically, for some embodiments, the PP fraud detector 132 may first determine an initial risk score for the transaction based, at least in part on the merchant metadata, and then dynamically adjust the risk score based on the merchant's current and past transactions, as well as other factors associated with the merchant (e.g., as described above with respect to FIGS. 2 and 3).

Once the risk score has been set, the system 100 may compare the risk score with a first risk threshold (403). For example, the first risk threshold may correspond to the lowest threshold under which no remedial action is to be taken. Thus, if the risk score is below the first risk threshold (403), the PP fraud detector 132 may simply forward on the payment request for processing (409). However, if the risk score exceeds the first risk threshold (403), the PP fraud detector 132 may notify a system administrator of the potentially-fraudulent transaction (404). For example, the PP fraud detector 132 may send a notification message to an administrator terminal.

The system 100 may further compare the risk score with a second risk threshold (405). For example, the second risk threshold may correspond to an intermediate threshold at which more substantial remedial action may be required. Thus, if the risk score exceeds the second risk threshold (405), the PP fraud detector 132 may initiate a thorough review of the transaction by a system administrator (406). However, if the risk score is below the second risk threshold (405) but above the first risk threshold (403), the PP fraud detector 132 may still proceed to forward on the payment request for processing (409).

Finally, the system 100 may compare the risk score with a third risk threshold (407). For example, the third risk threshold may correspond to the highest threshold above which a particular payment request may be deemed too risky to continue processing. Thus, if the risk score exceeds the third risk threshold (407), the PP fraud detector 132 may automatically decline the transaction (408). However, if the risk score is below the third risk threshold (407) but above the second risk threshold (405), the PP fraud detector 132 may put a hold on the payment request pending review by the system administrator (410). For example, if the system administrator ultimately determines that the transaction is too risky, the administrator may instruct the system 100 to decline the transaction. Otherwise, the administrator may notify the system 100 that it is safe to proceed with processing the payment request.

Computer

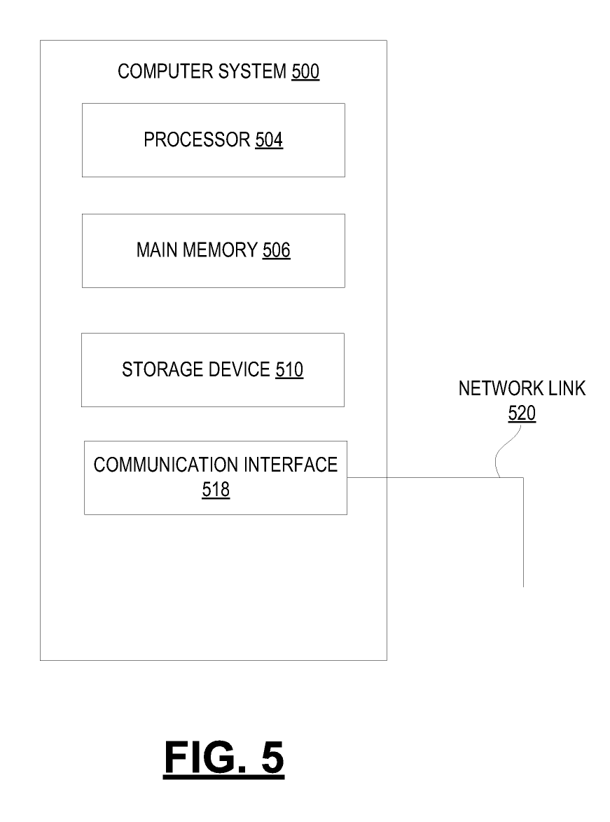

FIG. 5 is a block diagram that illustrates a computer system upon which embodiments described herein may be implemented. For example, in the context of FIG. 1, system 100 may be implemented using one or more servers such as described by FIG. 5.

In an embodiment, computer system 500 includes processor 504, memory 506 (including non-transitory memory), storage device 510, and communication interface 518. Computer system 500 includes at least one processor 504 for processing information. Computer system 500 also includes the main memory 506, such as a random access memory (RAM) or other dynamic storage device, for storing information and instructions to be executed by processor 504. Main memory 506 also may be used for storing temporary variables or other intermediate information during execution of instructions to be executed by processor 504. Computer system 500 may also include a read only memory (ROM) or other static storage device for storing static information and instructions for processor 504. The storage device 510, such as a magnetic disk or optical disk, is provided for storing information and instructions. The communication interface 518 may enable the computer system 500 to communicate with one or more networks through use of the network link 520 (wireless or wired line). The communication interface 518 may communicate with merchants and operators using, for example, the Internet.

Embodiments described herein are related to the use of computer system 500 for implementing the techniques described herein. According to one embodiment, those techniques are performed by computer system 500 in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for processing a commercial transaction, the method being implemented by one or more processors and comprising:
receiving a payment request from a merchant;
retrieving merchant metadata associated with a merchant profile based on the payment request;
determining an initial risk score for the transaction based, at least in part, on the merchant metadata; and
dynamically adjusting the risk score based on the received payment request and the merchant metadata.

2. The method of claim 1, wherein the payment request includes a payment amount for the commercial transaction.

3. The method of claim 2, wherein dynamically adjusting the risk score comprises:
increasing the risk score if the payment amount exceeds a threshold transaction size.

4. The method of claim 2, wherein the merchant metadata includes a previous amount charged by the merchant during a first period and a transaction limit for the first period, and wherein dynamically adjusting the risk score comprises:
increasing the risk score if the sum of the payment amount and the previous amount charged during the first period is equal to one or more predetermined transaction limits.

5. The method of claim 1, wherein the merchant metadata includes an age value corresponding to a length of time for which the merchant profile has been active, and wherein dynamically adjusting the risk score comprises:
increasing the risk score if the age value is below an age threshold.

6. The method of claim 5, wherein the merchant metadata further indicates a number of payments transacted by the merchant since the merchant profile has been active, and wherein dynamically adjusting the risk score comprises:
increasing the risk score if the number of payments transacted by the merchant is below a payment threshold.

7. The method of claim 6, further comprising:
adjusting the age value based on the number of payments transacted by the merchant.

8. The method of claim 7, wherein adjusting the age value includes:
reducing the age value if the number of payments transacted by the merchant is below the payment threshold.

9. The method of claim 1, wherein the merchant metadata includes an email address for the merchant, and wherein dynamically adjusting the risk score comprises:
increasing the risk score if the email address is associated with a public domain or a free service.

10. The method of claim 2, wherein the payment request includes payment card information, and wherein dynamically adjusting the risk score comprises:
increasing the risk score if the payment card information has been used in one or more previous transactions within a threshold duration prior to the commercial transaction.

11. The method of claim 10, wherein increasing the risk score further comprises:
increasing the risk score if the payment amount is reduced for each subsequent one of the one or more previous transactions.

12. The method of claim 1, wherein the merchant metadata indicates a frequency of declined payments, and wherein dynamically adjusting the risk score comprises:
increasing the risk score if the frequency of declined payments exceeds a card-sweeping threshold.

13. The method of claim 1, wherein the merchant metadata includes chargeback information, and wherein dynamically adjusting the risk score further comprises:
increasing the risk score if the chargeback information indicates one or more open chargebacks or disputes from cardholders.

14. The method of claim 1, further comprising:
determining, based on the risk score, to: (i) send a notification message to a system administrator indicating a high risk transaction, (ii) request a review of the transaction by the system administrator, or (iii) decline the transaction.

15. A computer system comprising:
a memory that stores instructions;
one or more processors, which access instructions from the memory to perform operations including:
receive a payment request from a merchant;
retrieve merchant metadata associated with a merchant profile based on the payment request;
determine an initial risk score for the transaction based, at least in part, on the merchant metadata; and
dynamically adjust the risk score based on the received payment request and the merchant metadata.

16. The computer system of claim 15, wherein the payment request includes a payment amount for the commercial transaction, and wherein the one or more processors dynamically adjust the risk score by:
increasing the risk score if the payment amount exceeds a threshold transaction size.

17. The computer system of claim 16, wherein the merchant metadata includes a previous amount charged by the merchant during a first period and a transaction limit for the first period, and wherein the one or more processors dynamically adjust the risk score by:
increasing the risk score if the sum of the payment amount and the previous amount charged during the first period is equal to one or more predetermined transaction limits.

18. The computer system of claim 15, wherein the merchant metadata includes an age value corresponding to a length of time for which the merchant profile has been active, and wherein the one or more processors are to dynamically adjust the risk score by:
increasing the risk score if the age value is below an age threshold.

19. The computer system of claim 15, wherein the memory further includes instructions that cause the one or more processors to:
determine, based on the risk score, to: (i) send a notification message to a system administrator indicating a high risk transaction, (ii) request a review of the transaction by the system administrator, or (iii) decline the transaction.

20. A computer-readable medium that stores instructions that, when executed by one or more processors, cause the one or more processors to perform operations comprising:
receiving a payment request from a merchant;
retrieving merchant metadata associated with a merchant profile based on the payment request;
determining an initial risk score for the transaction based, at least in part, on the merchant metadata; and
dynamically adjusting the risk score based on the received payment request and the merchant metadata.
